(19) United States
(12) Patent Application Publication
(10) Pub. No.: US 2006/0031162 A1
(43) Pub. Date: Feb. 9, 2006

(54) Linking from paper invoices and statements to on-line resources

(76) Inventors: Trent J. Brundage, Portland, OR (US); William C. Hein III, Glenmoore, PA (US)

Correspondence Address: DIGIMARC CORPORATION, 9405 SW GEMINI DRIVE, BEAVERTON, OR, 97008, US

(21) Appl. No.: 11/244,907

(22) Filed: Oct. 5, 2005

Related U.S. Application Data
(63) Continuation of application No. 09/631,409, filed on Aug. 3, 2000.

(51) Int. Cl. H04L 9/00

(52) U.S. Cl. 705/50

(57) ABSTRACT

Invoices, bank statements, checks, and other transactional paperwork is encoded with a steganographic digital watermark that encodes identification information. When a user shows such a paper (e.g., an invoice) to an optical input device associated with a computer, a browser session is initiated that uses the identification information to transport the user to a web page corresponding to that invoice. The web page provides a variety of functionality, including account review and payment, and customer service.

### RELATED APPLICATION DATA

This application is a continuation of application Ser. No. 09/631,409, filed Aug. 3, 2000.

### FIELD OF THE INVENTION

The present invention relates to invoices, bank statements, and other account paperwork that is exchanged between parties in connection with commercial transactions, and more particularly relates to the integration of such paperwork with on-line systems.

### DETAILED DESCRIPTION

In application Ser. No. 09/571,422, filed May 15, 2000 (now U.S. Pat. No. 6,947,571), the present assignee disclosed various arrangements for linking from physical objects (e.g., business cards, milk cartons, etc.), to associated on-line resources. The physical objects can be marked with steganographic digital watermarks (e.g., as detailed in application Ser. No. 09/503,881, filed Feb. 14, 2000, now U.S. Pat. No. 6,614,914), or by other machine-readable indicia such as bar-codes, data glyphs, etc.

In accordance with the present invention, these same principles are applied to invoices, bank statements, and similar account paperwork.

More particularly, such paperwork includes indicia that encodes information corresponding to an on-line address. When the indicia is sensed by a corresponding sensor (e.g., a web cam), the address information is decoded, and a link is established between the user's computer and the corresponding on-line address. Most commonly, the encoded information is an identifier that is used to index a database record containing the on-line address. This address is then provided to an Internet browser on the user's computer, permitting a corresponding web page to be loaded. In other embodiments, the on-line address can be directly encoded in the indicia.

In the case of a utility bill or the like, a consumer shows the bill to the web cam. (The bill can be held in front of the camera, or the camera can be held over the bill.) Browser software on the consumer's computer responds an instant later with a web page customized to that user, including an electronic version of the bill. A user interface included on the web page permits the consumer to authorize electronic payment of some or all of the amount due, either by credit card, electronic funds transfer from a bank account, or otherwise. Account review (both current and historical), customer service, and related services can also be provided via the web page. The web page may also include third party targeted advertising, as well as promotional information provided by the billing company (e.g., a cable company may use such web sites to inform customers of upcoming events, a telephone company may use the sites to promote special offers, etc.)

In addition to on-line payment, such a web page may provide for printing of a corresponding paper check at the user's computer—with the payee, amount, and date fields filled in automatically so as to prevent transcription errors. This functionality may be provided by a linkage between the web data and check-writing features of programs such as Microsoft Money or Quicken. Or the web page can include an embedded aplet that directly prints a corresponding check from the user's computer, etc. Regardless of payment technique, the system can update the user's corresponding account information accordingly (e.g., entering an electronic payment in an on-line check register).

Such an arrangement offers the best of the print and electronic worlds. For the customer, it reduces the time to pay bills, and avoids the time and expense associated with writing and mailing checks. Payments can be controlled by the customer to meet their particular needs (e.g., scheduling of payments, making partial payments). The system is simple—just show the paper invoice to the computer. And the system is failsafe, in that if the electronic network goes down, the user can write a check based on the paper invoice, as always.

For the billing business, the system reduces administration costs by reducing physical mail and check processing, while providing enhances customer service. And the provision of targeted advertising provides a further revenue opportunity, and provides enhanced customer service.

Much the same arrangement can be used with bank statements—for checking accounts and the like. The paper statement mailed to the customer is digitally watermarked, permitting an on-line version of the statement to be accessed simply by showing the paper to a web cam. Customary on-line banking tools can be included at the web site, including interfaces with common on-line banking software such as Microsoft Money and Quicken. (Indeed, the watermark reader may be included as an element of such software, or as an auxiliary utility that cooperates with the on-line banking software.)

Likewise, checks can be digitally watermarked—both checks printed by commercial check printers, and checks printed on home computers using various home banking software. The watermark can uniquely identify the check. When such a check is presented to a webcam, associated software can link to a database to obtain, and display, information relating to the check. The database can be on a remote computer (e.g., the bank's computer), or can be local (e.g., a check register maintained on by a home computer software application, such as Microsoft Money, or Quicken).

In all such approaches, a generally increased level of security is inherent, since the system relies on custody of the physical invoice or bank statement to gain access to the web page—a circumstance that imposters will find difficult to imitate. This circumstance notwithstanding, the web page may also include password protection or other security measures to guard against unauthorized access, e.g., from discarded account paperwork. (Account paperwork older than a set threshold, e.g., 45 days, may be disabled from access, if desired, to help protect against unauthorized use.)

To provide a comprehensive disclosure without unduly lengthening this specification, applicant incorporates by reference the patent applications cited above.

Having described and illustrated the principles of my invention with reference to specific embodiments, it will be recognized that the principles thereof can be implemented in many other, different, forms.

For example, while the detailed description contemplated use in conjunction with a web cam and personal computer, a great variety of other platforms can also be employed. These include set top boxes, smart phones, palm computers and organizers, etc.—any of which can provide Internet linking.

Likewise, while the detailed description particularly contemplated use of digital watermark technology, some of the same advantages can be achieved through use of other machine readable indicia, including bar codes, data glyphs, etc.

Moreover, the particular combinations of elements and features in the above-detailed embodiments are exemplary only; the interchanging and substitution of these teachings with teachings in the incorporated-by-reference applications are also contemplated.

In view of the wide variety of embodiments to which the principles and features discussed above can be applied, it should be apparent that the detailed embodiments are illustrative only and should not be taken as limiting the scope of the invention. Rather, we claim as our invention all such modifications as may come within the scope and spirit of the following claims and equivalents thereof.

We claim:

1. An invoice having a machine readable indicia thereon, said indicia representing plural bits of binary data, said indicia being generally un-intelligible to human observers thereof, the binary data represented by said indicia serving to indicate an on-line computer address associated with said invoice, wherein presentation of said invoice to a suitably-programmed device causes said device to establish a link to a computer address associated with said invoice.

2. The invoice of claim 1 wherein the indicia includes an identifier that is associated with said on-line computer address through a database record.

3. The invoice of claim 1 wherein the binary data represents said on-line computer address.

4. The invoice of claim 1 wherein said indicia comprises a steganographic digital watermark.

5. The invoice of claim 1 wherein said indicia comprises a barcode.

6. A checking account statement having a machine readable indicia thereon, said indicia representing plural bits of binary data, said indicia being generally unintelligible to human observers thereof, the binary data represented by said indicia serving to indicate an on-line computer address associated with said checking account statement, wherein presentation of said statement to a suitably-programmed device causes said device to establish a link to a computer address associated with said statement.

7. A printed check having a steganographic digital watermark encoded thereon, said watermark representing plural bits of binary data, the binary data represented by said watermark serving to indicate an on-line computer address associated with said check, wherein presentation of said check to a suitably-programmed device causes said device to establish a link to a computer address associated with said check.

8. An on-line method of paying finds from a first party to a second party in accordance with a statement detailing an amount owed, comprising:
the first party receiving said statement, on paper, by conventional mail;
the first party presenting at least a portion of said paper to an optical sensor; and
processing data from said optical sensor, including displaying a page of electronic information related to said statement on a screen of a data terminal.

9. A method comprising:
using an image sensor in a cell phone to capture image data from a printed document, said document being selected from the group consisting of an invoice, check, or checking account statement;
decoding from the captured image data certain machine readable data encoded on said document;
by reference to the decoded machine readable data, establishing a link from said cell phone to a remote computer; and
presenting information on a display of said cell phone, at least some of said information being related to data received from the remote computer relating to said document.

10. The method of claim 9 wherein the document comprises an invoice.

11. The method of claim 10 wherein said information presented on the display of the cell phone permits a user to review a history of transactions involving an account associated with said invoice.

12. The method of claim 10 wherein said information presented on the display of the cell phone permits a user to print a paper check in response to the invoice, with the payment, amount, and date fields filled-in automatically.

13. The method of claim 10 wherein said information presented on the display of the cell phone permits a user to authorize an electronic payment in partial or complete fulfillment of said invoice.

14. The method of claim 9 wherein the document comprises a checking account statement.

15. The method of claim 14 wherein said information presented on the display of the cell phone permits a user to interface with online banking software related to said account.

16. The method of claim 9 wherein the document comprises a check.

17. The method of claim 16 wherein said information presented on the display of the cell phone includes information read from a database and relating to said check.
